(19) United States
(12) Patent Application Publication
(10) Pub. No.: US 2017/0197600 A1
(43) Pub. Date: Jul. 13, 2017

(54) BRAKE CONTROL SYSTEM

(71) Applicant: HITACHI AUTOMOTIVE SYSTEMS, LTD., Hitachinaka-shi, Ibaraki (JP)

(72) Inventor: Nobuyuki OHTSU, Isehara-shi, Kanagawa (JP)

(73) Assignee: HITACHI AUTOMOTIVE SYSTEMS, LTD., Hitachinaka-shi, Ibaraki (JP)

(21) Appl. No.: 15/324,368

(22) PCT Filed: Jul. 10, 2015
(86) PCT No.: PCT/JP2015/069850

§ 371 Date: Jan. 6, 2017

(30) Foreign Application Priority Data
Jul. 14, 2014 (JP) 2014-144201

(51) Int. Cl. B60T 8/40; B60T 8/34

(52) U.S. Cl. CPC B60T 8/404; B60T 8/341; B60T 8/4022; B60T 2201/12; B60T 2201/02; B60T 2201/08; B60Y 2306/09

(57) ABSTRACT

a brake control system adapted to prevent or reduce noise is provided.

A brake control system switches a pressure increase mode between first pressure increase that closes a differential pressure valve placed between a master cylinder and a wheel cylinder and activates a pump to increase wheel cylinder hydraulic pressure and second pressure increase that allows brake fluid to leak through the differential pressure valve and activates the pump to increase the wheel cylinder hydraulic pressure, according to the state of a vehicle.

### TECHNICAL FIELD

The present invention relates to a brake control system.

### BACKGOUND ART

The technology described in Patent Document 1 below has been disclosed as a technology of this kind. Patent Document 1 discloses the technology that employs a pulse-pressure decreasing unit to reduce the noise made by pulse pressure of the brake fluid that is discharged from a pump.

### CITATION LIST

### Patent Document

Patent Document 1: Japanese Unexamined Patent Application Publication (Kokai) No. 2005-096520

### SUMMARY OF INVENTION

Patent Document 1 employs a pulse-pressure decreasing unit that is separately provided, which might increase costs.

The present invention has been made in light of the foregoing problem. An object of the invention is to provide a brake control system capable of controlling noise without adding another unit.

To accomplish the object mentioned above, a first embodiment of the invention switches a pressure increase mode between first pressure increase which closes a differential pressure valve placed between a master cylinder and wheel cylinders and activates a pump to increase a wheel cylinder hydraulic pressure, and second pressure increase which allows a brake fluid leak caused by the differential pressure valve and activates the pump to increase the wheel cylinder hydraulic pressure, according to a state of a vehicle.

According to a second embodiment, when a braking force command is issued to achieve a pressure increase gradient lower than a predetermined pressure increase gradient or issued at an early stage of pressure increase, the first pressure increase is carried out in which the differential pressure valve placed between the master cylinder and the wheel cylinders is brought into a closing direction, and a motor is driven to increase the wheel cylinder hydraulic pressure in accordance with motor rotational frequency. When the braking force command is issued to achieve a pressure increase gradient equal to or higher than the predetermined pressure increase gradient or issued at a late stage of the pressure increase, the second pressure increase is carried out in which brake fluid is refluxed from a downstream side toward an upstream side of a first hydraulic pressure circuit through the differential pressure valve with the motor set at a predetermined or higher rotational frequency, and the motor is driven to increase the wheel cylinder hydraulic pressure.

According to a third embodiment, the first pressure increase and the second pressure increase are carried out in accordance with the braking force command. The first pressure increase brings the differential pressure valve placed between the master cylinder and the wheel cylinders into the closing direction and increases the wheel cylinder hydraulic pressure in accordance with the rotational frequency of the pump when a condition of the braking force command is that the wheel-cylinder pressure increase demand is lower than a predetermined pressure increase responsivity demand. The second pressure increase refluxes the brake fluid from the downstream side toward the upstream side of the first hydraulic pressure circuit through the differential pressure valve with the motor set at the predetermined or higher rotational frequency and activates the motor to increase the wheel cylinder hydraulic pressure when the condition of the braking force command is that the wheel-cylinder pressure increase demand is equal to or higher than the predetermined pressure increase demand.

The first to third embodiments thus prevent or reduce noise made by the pulse pressure of the pump during the first pressure increase, and improve accuracy in hydraulic pressure control during the second pressure increase.

### BRIEF DESCRIPTION OF DRAWINGS

FIG. 1 shows a hydraulic pressure circuit located in a hydraulic pressure control unit of a first embodiment.

FIG. 2 is a time chart of the first embodiment.

FIG. 3 is a time chart of a comparative example.

FIG. 4 is a time chart of a second embodiment.

FIG. 5 is a time chart of a third embodiment.

FIG. 6 is a map showing an estimate value of brake fluid temperature relative to engine water temperature of the third embodiment.

FIG. 7 is a time chart of a fourth embodiment.

FIG. 8 is a time chart of a fifth embodiment.

FIG. 9 is a time chart of a sixth embodiment.

FIG. 10 is a flowchart of a seventh embodiment.

FIG. 11 is a flowchart of the seventh embodiment.

FIG. 12 is a flowchart of the seventh embodiment.

### DESCRIPTION OF EMBODIMENTS

### Embodiment 1

A brake control system of a first embodiment will be described below.

### [Configuration of a Hydraulic Pressure Control Unit]

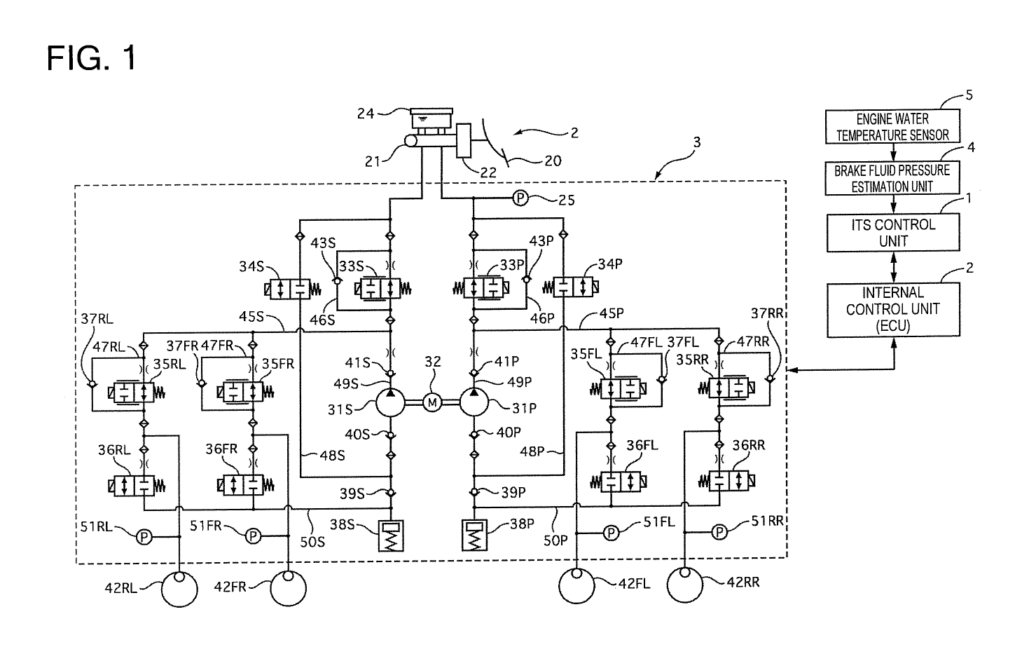

FIG. 1 shows a hydraulic pressure circuit located in a hydraulic pressure control unit 3. The hydraulic pressure control unit 3 includes an internal control unit 2. The internal control unit 2 controls a motor 32 and valves on the basis of a variety of information. The internal control unit 2 is connected to an ITS control unit 1 through a controller area network (CAN). The ITS control unit 1 calculates a target hydraulic pressure of each wheel cylinder 42 on the basis of Automatic Emergency Braking (AEB: automatic emergency break), Electronic Stability Control (ESC: skidding prevention device), Adaptive Cruise Control (ACC: automatic adaptive cruise control system), Lane Departure Prevention (LDP: lane departure prevention assist system), etc. The ITS control unit 1 receives an estimate value of brake fluid temperature which is input from a brake fluid temperature estimation unit 4. The brake fluid temperature estimation unit 4 estimates brake fluid temperature from a value of an engine water temperature sensor configured to measure engine water temperature.

The hydraulic pressure circuit is divided into two systems including a primary system and a secondary system. A left front wheel cylinder 42FL and a right rear wheel cylinder 42RR are connected to the primary system, and a right front wheel cylinder 42FR and a left rear wheel cylinder 42RL are connected to the secondary system, thereby forming a so-called X-split pipe configuration. Hereinafter, constituent elements of the primary system will be provided with reference marks attached with “P”, and those of the secondary system will be provided with reference marks attached with “S”. In this regard, however, neither “P” nor “S” will be attached when the distinction is not necessary. Configurations provided so asu to correspond to respective wheels will be provided with reference marks attached with “FL”, “FR”, “RL” or “RR”. When the distinction is not necessary, none of “FL”, “FR”, “RL” and “RR” will be attached.

The primary and secondary systems are provided with plunger pumps 31P and 31S, respectively. The plunger pumps 31 are driven by the single motor 32.

A master cylinder 21 is provided with a reservoir tank 24. Brake fluid is stored in the reservoir tank 24. The master cylinder 21 is further provided with a master back 22 that is a booster. When a brake pedal 20 is operated by driver, the master cylinder 21 supplies the brake fluid stored in the reservoir tank 24 into a hydraulic pressure circuit.

The master cylinder 21 is connected to the left front wheel cylinder 42FL and the right rear wheel cylinder 42RR through a fluid path 45P. The master cylinder 21 is connected to the right front wheel cylinder 42FR and the left rear wheel cylinder 42RL through a fluid path 45S. The fluid paths 45 are provided with gate out valves 33P and 33S that are normally open proportional valves. In the fluid paths 45, there are formed bypass fluid paths 46P and 46S that bypass the gate out valves 33. The bypass fluid paths 46 are provided with check valves 43P and 43S. The check valves 43 allow the brake fluid to flow from the master cylinder 21 toward the wheel cylinders 42 and inhibit a reverse flow.

Solenoid in valves 35FL, 35FR, 35RL, and 35RR that are normally open proportional valves are placed in the fluid paths 45 to be located between the respective gate out valves 33 and the respective wheel cylinders 42. In the fluid paths 45, there are formed bypass fluid paths 47FL, 47FR, 47RL, and 47RR that bypass the respective solenoid in valves 35. Formed in the bypass fluid paths 47 are check valves 37FL, 37FR, 37RL, and 37RR. The check valves 37 allow the brake fluid to flow from the wheel cylinders 42 toward the master cylinder 21 and inhibit a reverse flow.

The master cylinder 21 is connected with a suction side of each plunger pump 31 through fluid paths 48P and 48S. Gate in valves 34P and 34S that are normally closed on-off valves are placed in the fluid paths 48. Suction valves 40P and 40S are placed in the fluid paths 48 to be located between the respective plunger pumps 31 and the respective gate in valves 34. The suction valves 40 allow the brake fluid to flow in such a direction as to be sucked by the plunger pumps 31 and inhibit a reverse flow.

Portions of the fluid paths 45 which extend between the gate out valves 33 and the solenoid in valves 35 are connected to the respective plunger pumps 31 through fluid paths 49P and 49S. The fluid paths 49 are provided with discharge valves 41P and 41S. The discharge valves 41 allow the brake fluid to be discharged from the plunger pumps 31 and inhibit a reverse flow.

Portions of the fluid paths 45 which extend between the solenoid in valves 35 and the wheel cylinders 42 are connected to portions of the fluid paths 48 which extend between the gate in valves 34 and the suction valves 40 though fluid paths 50P and 50S. The fluid paths 50 are provided with solenoid out valves 36FL, 36FR, 36RL, and 36RR that are normally closed on-off valves. Reservoirs 38P and 38S are placed in the fluid paths 50 to be located between the respective solenoid valves 36 and the respective suction valves 40. Check valves 39P and 39S are placed in the fluid paths 50 to be located closer to the plunger pumps 31 than the reservoirs 38 are. The check valves 39 allow the brake fluid to flow from the reservoirs 38 toward the plunger pumps 31 and inhibit a reverse flow.

A master cylinder hydraulic pressure sensor 25 is placed in the fluid path 45P of the primary side to be located between the master cylinder 21 and the gate out valve 33P. The master cylinder hydraulic pressure sensor 25 may be placed within the master cylinder 21, instead of being placed within the hydraulic pressure control unit 3.

Wheel cylinder hydraulic sensors 51FL, 51FR, 51RL, and 51RR are placed in the fluid paths 45 to be located between the respective wheel cylinders 42 and the respective solenoid in valves 35.

### [Hydraulic Pressure Control]

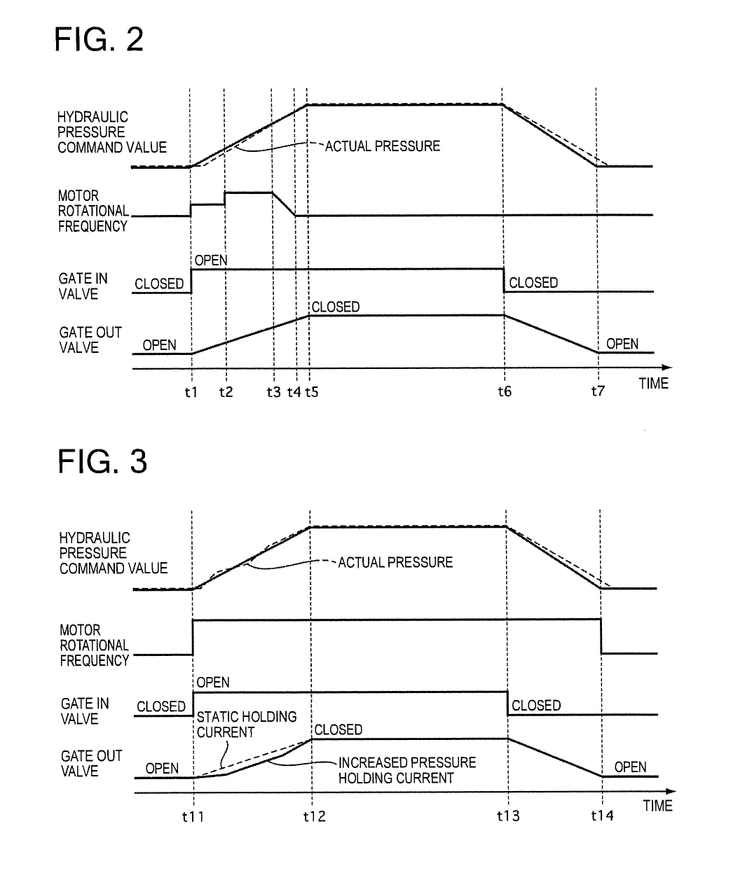

FIG. 2 is a time chart showing a hydraulic pressure command value calculated by the ITS control unit 1 during ACC or LDP, motor rotational frequency, control currents of the gate in valves 34, and control currents of the gate out valves 33.

At time t1, the hydraulic pressure command value starts increasing. In response to the increase of the hydraulic pressure command value, the gate in valves 34 are opened. The motor 32 then starts rotating, and the plunger pumps 31 are activated. The rotational frequency of the motor 32 is set so that hydraulic pressure according to the hydraulic pressure command value may be generated by the plunger pumps 31. At this time, the gate out valves 33 are set not to be opened if the hydraulic pressure is slightly higher than the hydraulic pressure command value, so that brake fluid leak control by the gate out valves 33 is not implemented.

At time t2, the rotational frequency of the motor 32 is increased. The rotational frequency of the motor 32 is set so that the wheel cylinder hydraulic pressure that is higher than the hydraulic pressure command value may be generated by the plunger pumps 31. At this time, the gate out valves 33 are set to be opened when the hydraulic pressure exceeds the hydraulic pressure command value, so that the brake fluid leak control is implemented by the gate out valves 33.

At time t3, actual pressure approaches the hydraulic pressure command value. The rotational frequency of the motor 32 is therefore reduced.

At time t4, the actual pressure is substantially equal to the hydraulic pressure command value. The rotational of the motor 32 is therefore stopped.

At time t5, the hydraulic pressure command value becomes constant. The gate out valves 33 are fully closed to maintain the hydraulic pressure.

At time t6, the hydraulic pressure command value is decreased. The gate in valves 34 are therefore closed, and the control currents of the gate out valves 33 are reduced according to the hydraulic pressure command value.

At time t7, the hydraulic pressure command value reaches zero. The gate out valves 33 are fully opened.

### COMPARATIVE EXAMPLE

FIG. 3 is a time chart showing a comparative example of Embodiment 1. As with FIG. 2, FIG. 3 shows the hydraulic pressure command value calculated by the ITS control unit 1 during ACC or LDP, the rotational frequency of the motor, the control currents of the gate in valves 34, and the control currents of the gate out valves 33.

At time t11, the hydraulic pressure command value starts increasing. In response to the increase of the hydraulic pressure command value, the gate in valves 34 are opened. The motor 32 then rotates, and the plunger pumps 31 are activated.

The rotational frequency of the motor 32 is set higher than that in Embodiment 1. At this time, the gate out valves 33 are set to be opened when the hydraulic pressure exceeds the hydraulic pressure command value, so that the brake fluid leak control is implemented by the gate out valves 33. In other words, the gate out valves 33 are controlled at all times by increased pressure holding current that is lower than control current (static holding current) at which the gate out valves 33 can be closed.

At time t12, the hydraulic pressure command value becomes constant. The gate in valves 34 are closed, and the gate out valves 33 are also fully closed. The motor 32 continues to rotate beyond the time t12. However, the gate in valves 34 are closed, so that the brake fluid is not supplied from the reservoir tank 24. The hydraulic pressure is therefore not increased.

At time t13, the hydraulic pressure command value is decreased. The control currents of the gate out valves 33 are then reduced according to the hydraulic pressure command value.

At time t14, the hydraulic pressure command value reaches zero, and the gate out valves 33 are fully opened. The motor 32 is stopped.

[Operation]

The comparative example constantly rotates the motor 32 while the hydraulic pressure command value is being generated. The hydraulic pressure control is more accurate when implemented through the brake fluid leak control using the gate out valves 33, as compared to when implemented by adjusting rotational frequency of the plunger pumps 31. In the brake fluid leak control, however, the rotational frequency of the motor 32 is set so high as to be able to generate higher hydraulic pressure than required hydraulic pressure. The high rotational frequency of the motor 32 and the plunger pumps 31 creates a loud operation noise, which might bring a discomfort feeling to an occupant.

In this light, Embodiment 1 closes the gate out valves 33 in an early stage of braking (between time t1 and time t2) and does not carry out the brake fluid leak control using the gate out valves 33 (first pressure increase). Without the brake fluid leak control, the rotational frequency of the motor 32 can be reduced. The early stage of braking is a time period before a braking force is generated in a vehicle. During the above-mentioned time period, a brake disc and a brake pad are not in contact, so that noise other than the operation noise of the motor 32 and the plunger pumps 31 are low, which makes the occupant more likely to be annoyed by the operation noise of the motor 32 and the plunger pumps 31. In the early stage of braking, furthermore, since the braking force is not generated, the hydraulic pressure control is not required to be highly accurate. For that reason, the rotational frequency of the motor 32 is reduced by suspending the brake fluid leak control as described above. This makes it possible to prevent or reduce the noise created by the motor 32 and the plunger pumps 31 during a time period when such a noise is likely to annoy the occupant.

According to Embodiment 1, in a late stage of braking (between time t2 and time t5), the gate out valves 33 are opened/closed to implement the brake fluid leak control using the gate out valves 33 (second pressure increase). In the late stage of braking, the brake disc and the brake bad are in contact, so that noise other than the operation noise of the motor 32 and the plunger pumps 31 is generated. In other words, the occupant is unlikely to be annoyed by the noise created by the motor 32 and the plunger pumps 31. At this time, the brake fluid leak control is implemented in which the hydraulic pressure control is highly accurate.

[Advantages]

(1) Embodiment 1 includes the fluid paths 45 (first hydraulic pressure circuit) connecting the master cylinder 21 and the wheel cylinders 42 disposed at respective wheels; the gate out valves 33 (differential pressure valves) placed in the fluid paths 45 and configured to adjust a differential pressure between a downstream side connected to the wheel cylinder 42-side, and an upstream side connected to the master cylinder 21-side; the plunger pumps 31 (pumps) configured to discharge the brake fluid to between the gate out valves 33 of the fluid paths 45 and the wheel cylinders 42; and the ITS control unit 1 (hydraulic pressure control unit) configured to increase the hydraulic pressure of the wheel cylinder provided at the wheels by using the gate out valves 33 and the plunger pumps 31, on the basis of the braking force command calculated according to a state of a vehicle or the wheels. The ITS control unit 1 switches a pressure increase mode between the first pressure increase that closes the gate out valves 33 and activates the plunger pumps 31 to increase the wheel cylinder hydraulic pressure, and the second pressure increase that allows the brake fluid to leak through the gate out valves 33 and flow from the downstream side to the upstream side of the fluid paths 45 and activates the plunger pumps 31 to increase the wheel cylinder hydraulic pressure, according to a state of the vehicle.

It is then possible, during the first pressure increase, to prevent or reduce the generation of noise created by pulse pressure of the plunger pumps 31. During the second pressure increase, the hydraulic pressure control is improved in accuracy.

(2) The ITS control unit 1 is configured to carry out the first pressure increase during a predetermined time period from start of control.

This makes it possible to prevent or reduce the noise created by the motor 32 and the plunger pumps 31 during a time period when the noise is likely to annoy the occupant.

(3) A predetermined time period from start of control that carries out the first pressure increase is a time period before an actual braking force is generated in the vehicle.

The operation noise of the motor 32 and the plunger pumps 31 can be prevented or reduced during the time period when the operation noise of the motor 32 and the plunger pumps 31 is likely to annoy the occupant as there is not much other noise.

### Embodiment 2

Embodiment 2 differs from Embodiment 1 in method of controlling the motor 32. Constituent elements identical to those of Embodiment 1 will be provided with identical reference marks, and descriptions thereof will be omitted. Embodiment 2 implements control for eliminating backlash between the brake pad and the brake disc at the start of braking.

### [Hydraulic Pressure Control]

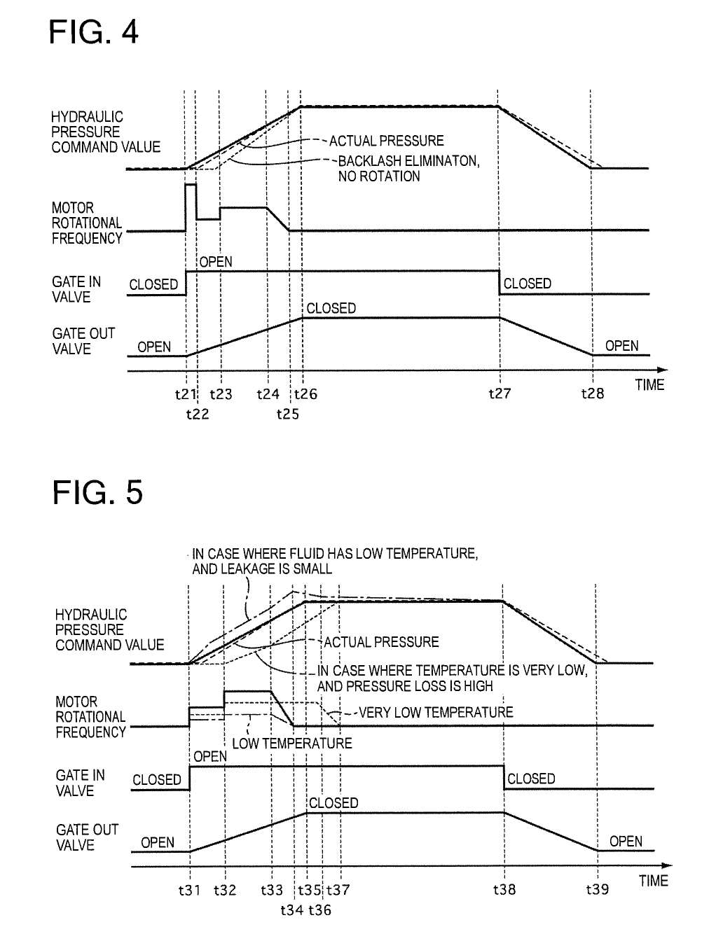

FIG. 4 is a time chart showing a hydraulic pressure command value calculated by the ITS control unit 1 during ACC or LDP, motor rotational frequency, control currents of the gate in valves 34, and control currents of the gate out valves 33.

At time t21, the hydraulic pressure command value starts increasing. In response to the increase of the hydraulic pressure command value, the gate in valves 34 are opened. The motor 32 then rotates, and the plunger pumps 31 are activated. The rotational frequency of the motor 32 is set higher than during the first and the second pressure increase of Embodiment 1. At time t23, the rotational frequency of the motor 32 is reduced. The rotational frequency of the motor 32 is set so that the hydraulic pressure according to the hydraulic pressure command value may be generated by the plunger pumps 31. At this time, the gate out valves 33 are set not to be opened when the hydraulic pressure is slightly higher than the hydraulic pressure command value, so that brake fluid leak control using the gate out valves 33 is not implemented.

At time t23, the rotational frequency of the motor 32 is increased. The rotational frequency of the motor 32 is set so that the wheel cylinder hydraulic pressure that is higher than the hydraulic pressure command value may be generated by the plunger pumps 31. At this time, the gate out valves 33 are set to be opened when the hydraulic pressure exceeds the hydraulic pressure command value, so that the brake fluid leak control is implemented using the gate out valves 33.

At time t24, actual pressure approaches the hydraulic pressure command value, so that the rotational frequency of the motor 32 is reduced.

At time t25, the actual pressure is substantially equal to the hydraulic pressure command value, so that the motor 32 is stopped.

At time t26, the hydraulic pressure command value becomes constant. The gate out valves 33 are fully closed to maintain the hydraulic pressure.

At time t27, the hydraulic pressure command value is decreased, so that the gate in valves 34 are closed, and the control currents of the gate out valves 33 are reduced according to the hydraulic pressure command value.

At time t28, the hydraulic pressure command value reaches zero. The gate out valves 33 are fully opened.

[Operation]

According to Embodiment 2, during a predetermined time period (between time t21 and time t22) from the start of braking, the rotational frequency of the motor 32 is set higher than it is during the first and the second pressure increase. In other words, the rotational frequency of the plunger pumps 31 is also controlled to be higher than it is during the first and the second pressure increase.

This makes it possible to eliminate backlash between the brake pad and the brake disc at the start of braking, and thus to prevent or reduce a response delay of rise in brake fluid pressure.

[Advantages]

(4) The ITS control unit 1 is configured to control the rotational frequency of the plunger pumps 31 during a predetermined time period from the start of control so that the rotational frequency of the plunger pumps 31 is higher than it is during the first and the second pressure increase.

This makes it possible to eliminate backlash between the brake pad and the brake disc at the start of braking, and thus to prevent or reduce a response delay of rise in brake fluid pressure.

(5) The predetermined time period where the rotational frequency of the plunger pumps 31 is controlled to be higher than it is during the first and the second pressure increase is a time period in which a gap created between the brake disc and the brake pad is eliminated.

Since the rotational frequency of the plunger pumps 31 is increased only for a short time period in which the elimination of the backlash between the brake disc and the brake pad takes place, a loud operation noise of the motor 32 and the plunger pumps 31 is generated only for a short time.

### Embodiment 3

Embodiment 3 differs from Embodiment 1 in method of controlling the motor 32. Constituent elements identical to those of Embodiment 1 will be provided with identical reference marks, and descriptions thereof will be omitted. Embodiment 3 changes the setting of the rotational frequency of the motor 32 in accordance with brake fluid temperature.

### [Hydraulic Pressure Control]

FIG. 5 is a time chart showing a hydraulic pressure command value calculated by the ITS control unit 1 during ACC or LDP, motor rotational frequency, control currents of the gate in valves 34, and control currents of the gate out valves 33.

At time t31, the hydraulic pressure command value starts increasing. In response to the increase of the hydraulic pressure command value, the gate in valves 34 are opened. The motor 32 then rotates, and the plunger pumps 31 are activated. The rotational frequency of the motor 32 is set so that the hydraulic pressure according to the hydraulic pressure command value may be generated by the plunger pumps 31. The rotational frequency of the motor 32 is set so as to be highest at room temperature, next highest at very low temperature, and lowest at low temperature. At this time, the gate out valves 33 are set not to be opened when the hydraulic pressure is slightly higher than the hydraulic pressure command value, so that brake fluid leak control using the gate out valves 33 is not implemented.

At time t32, the rotational frequency of the motor 32 is increased. The rotational frequency of the motor 32 is set so that the wheel cylinder hydraulic pressure that is higher than the hydraulic pressure command value may be generated by the plunger pumps 31. At this time, the gate out valves 33 are set to be opened when the hydraulic pressure exceeds the hydraulic pressure command value, so that the brake fluid leak control is implemented using the gate out valves 33.

At time t33, the actual pressure approaches the hydraulic pressure command value at room and low temperatures, so that the rotational frequency of the motor 32 is reduced.

At time t34, the actual pressure is substantially equal to the hydraulic pressure command value at room and low temperatures, so that the motor 32 is stopped.

At time t35, the hydraulic pressure command value becomes constant. The gate out valves 33 are fully closed to maintain the hydraulic pressure.

At time t36, the rotational frequency of the motor 32 is reduced at very low temperature.

At time t37, the motor is stopped at very low temperature. At time t38, the hydraulic pressure command value is decreased, so that the gate in valves 34 are closed, and the control currents of the gate out valves 33 are reduced in accordance with the hydraulic pressure command value.

At time t39, the hydraulic pressure command value reaches zero, so that the gate out valves 33 are fully opened.

[Estimation of Brake Fluid Temperature]

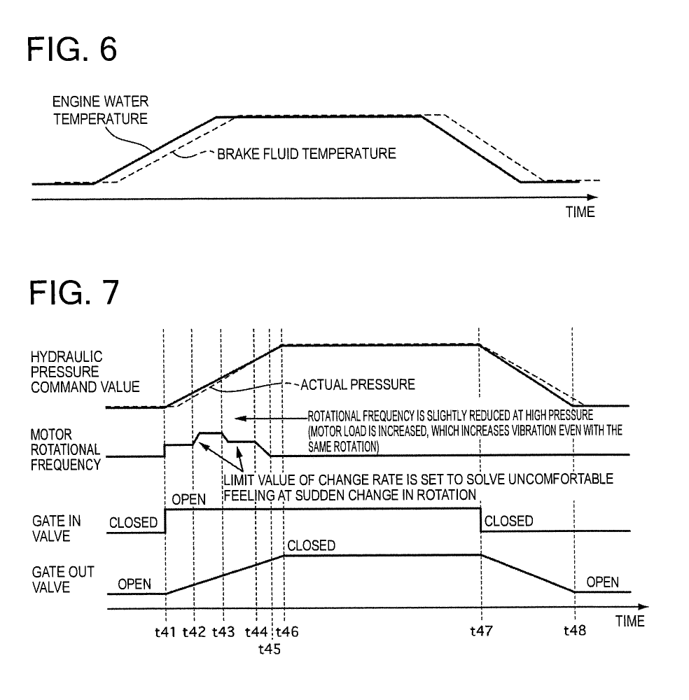

FIG. 6 is a graph showing an estimate value of brake fluid temperature relative to engine water temperature. Embodiment 3 estimates the brake fluid temperature from the engine water temperature. As the brake fluid temperature changes later than the engine water temperature, the estimate value of the brake fluid temperature is set to change later than the engine water temperature as shown in FIG. 6.

### [Operation]

In Embodiment 3, when the brake fluid has a low or very low temperature, engine rotational frequency is set lower than it is when the brake fluid has a room temperature. That is, the rotational frequency of the plunger pumps 31 is also controlled to be lower than it is when the brake fluid has a room temperature.

When the brake fluid temperature is high, the brake fluid is low in viscosity, and there are lots of leaks from the plunger pumps 31. In contrast, when the brake fluid temperature is low, the brake fluid is high in viscosity, and the leak from the plunger pumps 31 is small. When the brake fluid has a low or very low temperature, if the plunger pumps 31 are operated at the same rotational frequency as when the brake fluid has a room temperature, actual brake fluid becomes too high relative to the brake fluid pressure command value. When the brake fluid has a low or very low temperature, a discharge amount of the brake fluid can be adjusted to be in accordance with amount of the brake fluid leaking from the plunger pumps 31 by controlling the rotational frequency of the plunger pumps 31 to be low.

In Embodiment 3, when the brake fluid temperature is very low, the engine rotational frequency is set higher than it is when the brake fluid temperature is low. In other words, the rotational frequency of the plunger pumps 31 is controlled to be higher than it is when the brake fluid temperature is low.

When the brake fluid temperature is very low, the brake fluid is high in viscosity and cannot be smoothly sucked into the plunger pumps 31. This slows response of the brake fluid. When the brake fluid temperature is very low, the response of the brake fluid pressure can be quickened by controlling the rotational frequency of the plunger pumps 31 to be high.

Embodiment 3 estimates the brake fluid temperature from the engine water temperature. The brake fluid temperature can be estimated using an engine water temperature sensor 5 that is normally installed in the engine. This eliminates the necessity of separately providing a device for measuring the brake fluid temperature and thus reduces the number of components.

[Advantages]

(6) Embodiment 3 includes the brake fluid temperature estimation unit 4 configured to estimate the brake fluid temperature. According to the ITS control unit 1, when the estimated brake fluid temperature is equal to or lower than a predetermined brake fluid temperature, the rotational frequency of the pumps is set lower than it is when the estimated brake fluid temperature is higher than the predetermined brake fluid temperature.

The discharge amount of the brake fluid therefore can be adjusted to be in accordance with the amount of the brake fluid leaking from the plunger pumps 31.

(7) The brake fluid temperature estimation unit 4 estimates the brake fluid temperature on the basis of the water temperature of the engine installed in the vehicle.

This eliminates the necessity of separately providing a device for measuring the brake fluid temperature and thus reduces the number of components.

### Embodiment 4

Embodiment 4 differs from Embodiment 1 in method of controlling the motor 32. Constituent elements identical to those of Embodiment 1 will be provided with identical reference marks, and descriptions thereof will be omitted. Embodiment 4 changes the setting of the rotational frequency of the motor 32 in accordance with the wheel cylinder hydraulic pressure.

### [Hydraulic Pressure Control]

FIG. 7 is a time chart showing the hydraulic pressure command value calculated by the ITS control unit 1 during ACC or LDP, the rotational frequency of the motor, the control currents of the gate in valves 34, and the control currents of the gate out valves 33.

At time t41, the hydraulic pressure command value starts increasing. In response to the increase of the hydraulic pressure command value, the gate in valves 34 are opened. The motor 32 then rotates, and the plunger pumps 31 are activated. The rotational frequency of the motor 32 is set so that the hydraulic pressure according to the hydraulic pressure command value may be generated by the plunger pumps 31. At this time, the gate out valves 33 are set not to be opened when the hydraulic pressure is slightly higher than the hydraulic pressure command value, so that brake fluid leak control using the gate out valves 33 is not implemented.

At time t42, the rotational frequency of the motor 32 is increased. When the rotational frequency of the motor 32 is increased, a limit value to limit a change rate of the rotational frequency is set. The rotational frequency of the motor 32 is set so that the wheel cylinder hydraulic pressure higher than the hydraulic pressure command value may be generated by the plunger pumps 31. At this time, the gate out valves 33 are set to be opened when the hydraulic pressure exceeds the hydraulic pressure command value, and the brake fluid leak control is implemented using the gate out valves 33.

At time t43, the actual pressure (wheel cylinder pressure) becomes equal to or higher than predetermined hydraulic pressure. At this time, the rotational frequency of the motor 32 is reduced by a predetermined value. When the rotational frequency of the motor 32 is reduced, a limit value to limit a change rate of the rotational frequency is set.

At time t44, the actual pressure approaches the hydraulic pressure command value, so that the rotational frequency of the motor 32 is reduced.

At time t45, the actual pressure is substantially equal to the hydraulic pressure command value, so that the rotational of the motor 32 is stopped.

At time t46, the hydraulic pressure command value becomes constant. The gate out valves 33 are fully closed to maintain the hydraulic pressure.

At time t47, the hydraulic pressure command value is reduced. The gate in valves 34 are therefore closed, and the control currents of the gate out valves 33 are reduced in accordance with the hydraulic pressure command value.

At time t48, the hydraulic pressure command value reaches zero, and the gate out valves 33 are fully opened.

[Operation]

In Embodiment 4, the rotational frequency of the motor 32 is set low when the wheel cylinder hydraulic pressure becomes equal to or higher than predetermined hydraulic pressure (time t43) during the second pressure increase (between time t42 and time t43). In other words, the rotational frequency of the plunger pumps 31 is controlled to be low.

When the wheel cylinder hydraulic pressure becomes high, load of the motor 32 is increased. If the rotational frequency is intended to be maintained, vibration is increased, creating noise. If the wheel cylinder hydraulic pressure is predetermined hydraulic pressure, noise can be prevented or reduced by setting the rotational frequency of the motor 32 to be low.

In Embodiment 4, a limit value to limit a change rate of the rotational frequency of the motor 32 is set when increasing/decreasing the rotational frequency.

This makes it possible to prevent or reduce a discomfort feeling to the occupant which is caused by a sudden change of rotational frequency of the motor 32.

[Advantages]

(8) Embodiment 4 includes the wheel cylinder hydraulic pressure sensors 51 (wheel cylinder hydraulic pressure calculating units) configured to calculate the hydraulic pressure of the wheel cylinders. The ITS control unit 1 is configured to reduce the rotational frequency of the plunger pumps 31 by predetermined rotational frequency when the calculated wheel cylinder hydraulic pressure becomes equal to or higher than predetermined hydraulic pressure during the second pressure increase.

This makes it possible to prevent or reduce noise.

### Embodiment 5

Embodiment 5 differs from Embodiment 1 in method of controlling the motor 32. Constituent elements identical to those of Embodiment 1 will be provided with identical reference marks, and descriptions thereof will be omitted. Embodiment 5 sets the control currents of the gate out valves 33 relatively high at the time of the first pressure increase.

### [Hydraulic Pressure Control]

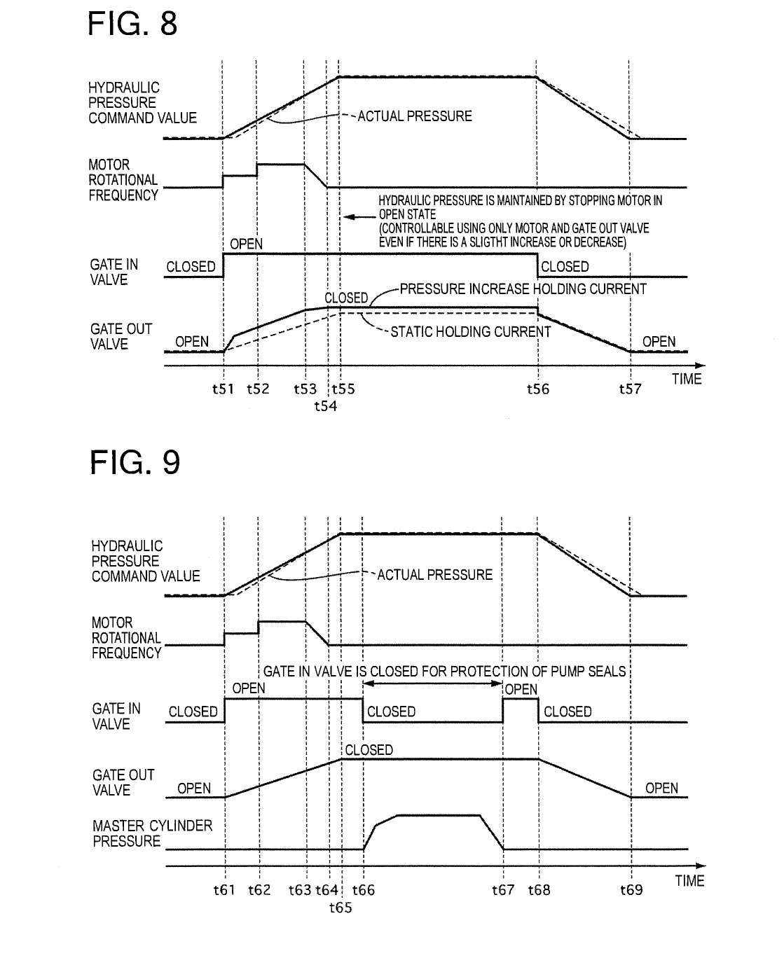

FIG. 8 shows the hydraulic pressure command value calculated by the ITS control unit 1 during ACC or LDP, the rotational frequency of the motor, the control currents of the gate in valves 34, and the control currents of the gate out valves 33.

At time t51, the hydraulic pressure command value starts increasing. In response to the increase of the hydraulic pressure value, the gate in valves 34 are opened. The motor 32 then rotates, and the plunger pumps 31 are activated. The rotational frequency of the motor 32 is set so that the hydraulic pressure according to the hydraulic pressure command value may be generated by the plunger pumps 31. At this time, the gate out valves 33 are set at a higher command value (static holding current command value) than the hydraulic pressure command value (holding current command value during the pressure increase) of Embodiment 1.

At time t52, the rotational frequency of the motor 32 is increased. The rotational frequency of the motor 32 is set so that the wheel cylinder hydraulic pressure that is higher than the hydraulic pressure command value may be generated by the plunger pumps 31. At this time, the gate out valves 33 are set to be opened when the hydraulic pressure exceeds the hydraulic pressure command value, so that the brake fluid leak control is implemented using the gate out valves 33.

At time t53, the actual pressure approaches the hydraulic pressure command value, so that the rotational frequency of the motor 32 is reduced.

At time t54, the actual pressure is substantially equal to the hydraulic pressure command value, so that the motor 32 is stopped. Since the motor 32 is stopped, the plunger pumps 31 are also stopped. However, the gate in valves 34 are left open.

At time t55, the hydraulic pressure command value becomes constant. The gate out valves 33 are fully closed to maintain the hydraulic pressure.

At time t56, the hydraulic pressure command value is decreased. The gate in valves 34 are therefore closed, and the control currents of the gate out valves 33 are reduced in accordance with the hydraulic pressure command value.

At time t57, the hydraulic pressure command value reaches zero, and the gate out valves 33 are fully opened.

[Operation]

Embodiment 5 sets high control currents of the gate out valves 33 during the first pressure increase (between time t51 and time t52).

This makes it possible to prevent or reduce the leak of the brake fluid from the gate out valves 33 during the first pressure increase in which the wheel cylinder pressure is controlled by the controlling the rotational frequency of the plunger pumps 31, instead of by the leak control using the gate out valves 33. The rotational frequency of the plunger pumps 31 thus can be reduced, which prevents or reduces the noise generation.

In Embodiment 5, the gate in valves 34 are left open even when the plunger pumps 31 are stopped (between time t54 and time t56).

The gate in valves 34 make noise when being opened or closed. Embodiment 5 prevents or reduces the noise by reducing the number of times of opening or closing the gate in valves 34.

[Advantages]

(9) The control currents of the gate out valves 33 are set to be high during the first pressure increase.

The rotational frequency of the plunger pumps 31 therefore can be reduced, which prevents or reduces the noise generation.

### Embodiment 6

Embodiment 6 differs from Embodiment 1 in method of controlling the gate in valves 34. Constituent elements identical to those of Embodiment 1 will be provided with identical reference marks, and descriptions thereof will be omitted. Embodiment 6 closes the gate in valves 34 when master cylinder pressure rises during a time period when the hydraulic pressure is maintained.

### [Hydraulic Pressure Control]

FIG. 9 is a time chart showing the hydraulic pressure command value calculated by the ITS control unit 1 during ACC or LDP, the rotational frequency of the motor, the control currents of the gate in valves 34, the control currents of the gate out valves 33, and the master cylinder pressure.

At time t61, the hydraulic pressure command value starts increasing. In response to the increase of the hydraulic pressure command value, the gate in valves 34 are opened. The motor 32 then rotates, and the plunger pumps 31 are activated. The rotational frequency of the motor 32 is set so that the hydraulic pressure according to the hydraulic pressure command value may be generated by the plunger pumps 31. At this time, the gate out valves 33 are set not to be opened when the hydraulic pressure is slightly higher than the hydraulic pressure command value, so that the brake fluid leak control using the gate out valves 33 is not implemented.

At time t62, the rotational frequency of the motor 32 is increased. The rotational frequency of the motor 32 is set so that the wheel cylinder hydraulic pressure that is higher than the hydraulic pressure command value may be generated by the plunger pumps 31. At this time, the gate out valves 33 are set to be opened when the hydraulic pressure exceeds the hydraulic pressure command value, and the brake fluid leak control is implemented using the gate out valves 33.

At time t63, the actual pressure approaches the hydraulic pressure command value, so that the rotational frequency of the motor 32 is reduced.

At time t64, the actual pressure is substantially equal to the hydraulic pressure command value, so that the motor 32 is stopped. Although the motor 32 is stopped, the gate in valves 34 are left open.

At time t65, the hydraulic pressure command value becomes constant. The gate out valves 33 are fully closed to maintain the hydraulic pressure.

At time t66, a driver steps on the brake pedal 20 and raises the master cylinder pressure. At this time, the control currents of the gate in valves 34 are switched off to close the gate in valves 34.

At time t67, the driver releases the brake pedal 20, which reduces the master cylinder pressure. At this time, the control currents of the gate in valves 34 are switched on to open the gate in valves 34.

At time t68, the hydraulic pressure command value is decreased. The gate in valves 34 are therefore closed, and the control currents of the gate out valves 33 are reduced in accordance with the hydraulic pressure command value.

At time t69, the hydraulic pressure command value reaches zero, and the gate out valves 33 are fully opened.

[Operation]

Embodiment 6 closes the gate in valves 34 when the driver steps on the brake pedal 20 during the time period when the hydraulic pressure is maintained, and the master cylinder hydraulic pressure is increased.

When the plunger pumps 31 are applied with high hydraulic pressure, seals located within the plunger pumps 31 might be damaged. When the master cylinder hydraulic pressure is increased, the plunger pumps 31 are prevented from being applied with high hydraulic pressure by closing the gate in valves 34. This prevents or reduces the damage on the seals.

[Advantages]

(10) Embodiment 6 includes the fluid paths 45 and 49 (suction oil passages) through which the plunger pumps 31 suck the brake fluid from the master cylinder 21, and the gate in valves 34 (suction valves) placed in the fluid paths 45. The ITS control unit 1 turns the gate in valves 34 to the open state during the first and the second pressure increase, and opens/closes the gate in valves 34 during the time period when the hydraulic pressure is maintained.

This prevents and reduces the damage on the seals of the plunger pumps 31.

(11) The ITS control unit 1 is configured to detect that the brake pedal 20 is operated by the driver during the time period when the hydraulic pressure is maintained.

This makes it possible to close the gate in valves 34 only when the master cylinder hydraulic pressure is increased, and thus prevent or reduce the noise created when the gate in valves 34 are opened/closed.

### Embodiment 7

Embodiment 7 differs from Embodiment 1 in method of controlling the motor 32. Constituent elements identical to those of Embodiment 1 will be provided with identical reference marks, and descriptions thereof will be omitted.

### [Hydraulic Pressure Control]

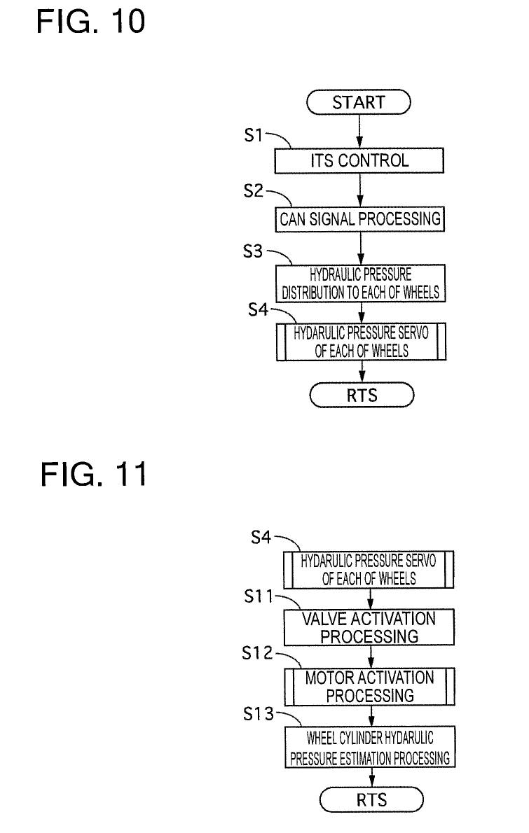

FIG. 10 is a flowchart showing a flow of controlling the wheel cylinder hydraulic pressure of each wheel.

In Step S1, target hydraulic pressures of the respective wheel cylinders 42 are calculated in the ITS control unit 1 on the basis of AEB, ESC, ACC and LDP. The process then proceeds to Step S2.

In Step S2, the target hydraulic pressures of the respective wheel cylinders 42 are sent to the internal control unit 2 through CAL. The process then advances to Step S3.

In Step S3, hydraulic pressure distribution processing to the wheels is performed in the internal control unit 2. The process then proceeds to Step S4.

In Step S4, activation processing of the valves in the hydraulic pressure control unit 3 and the motor 32 is performed. The process then ends.

FIG. 11 is a flowchart showing a flow of the activation processing of the valves and the motor 32 in Step S4.

In Step S11, the activation processing of the valves is performed. The process then proceeds to Step S12.

In Step S12, the activation processing of the motor 32 is performed. The process then proceeds to Step S13.

In Step S13, processing of estimating the wheel cylinder hydraulic pressure is performed. The process then ends.

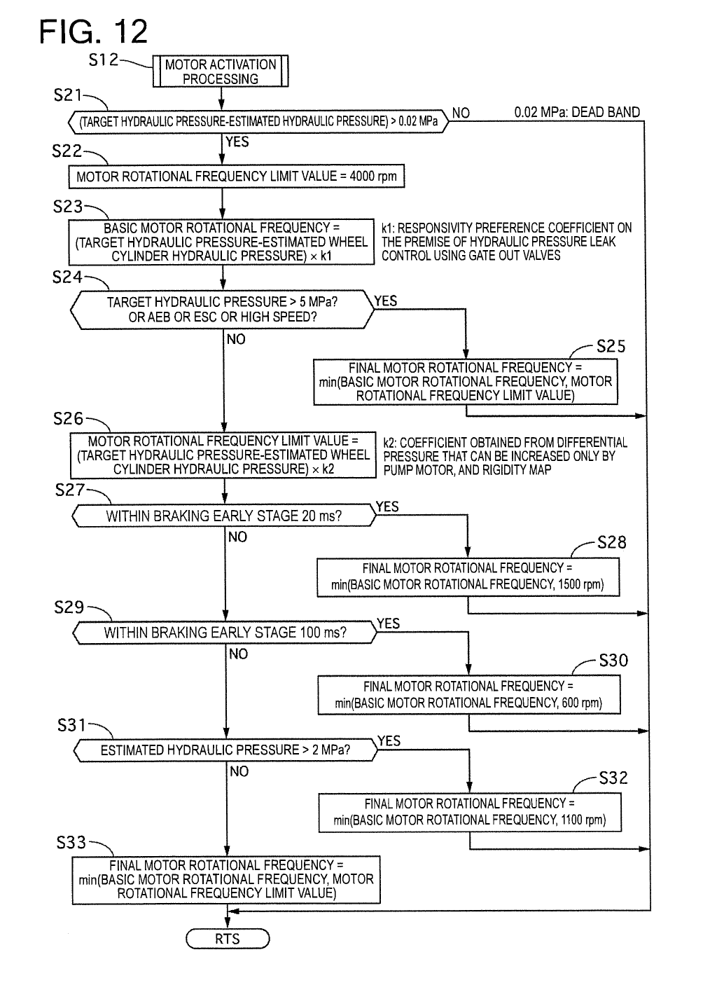

FIG. 12 is a flowchart showing a flow of the activation processing of the motor 32.

In Step S21, whether difference between the target hydraulic pressure and estimated hydraulic pressure of each of the wheel cylinders 42 is larger than 0.02 [Mpa] is determined. If the difference is larger than 0.02 [Mpa], the process proceeds to Step S22. The process ends if the difference is equal to or smaller than 0.02 [Mpa].

In Step S22, a limit value of the rotational frequency of the motor 32 is set to 4000 [rpm]. The process then proceeds to Step S23.

In Step S23, a basic motor rotational frequency i set in accordance with an expression below. The process then proceeds to Step S24.

Basic motor rotational frequency=(target hydraulic pressure-estimated hydraulic pressure)xkl, where the target hydraulic pressure is the target hydraulic pressure of each of the wheel cylinders 42; the estimated hydraulic pressure is the estimated hydraulic pressure of each of the wheel cylinders 42; and kl is a responsivity preference coefficient on the premise of the hydraulic pressure leak control using the gate out valves 33.

In Step S24, whether the target hydraulic pressure of each of the wheel cylinders 42 is larger than 5 [Mpa], whether AED is being applied, whether ESC is being carried out or whether the vehicle is traveling at high speed is determined. If any one of the foregoing conditions is satisfied, the process proceeds to Step S25. If not, the process proceeds to Step S26.

In Step S25, final motor rotational frequency is set to a smaller one between the basic motor rotational frequency and the limit value of the rotational frequency of the motor 32, and the process ends (second pressure increase).

In Step S26, the limit value of the rotational frequency of the motor 32 is set according to an expression below. The process then proceeds to Step S27.

Motor rotational frequency limit value=(target hydraulic pressure-estimated hydraulic pressure)×k2,

where k2 is a coefficient that is obtained from differential pressure that can be increased only by a driving force of the motor 32 and a rigidity map.

In Step S27, whether the amount of time elapsed from the start of braking is 20 [ms] or less is determined. If the amount of the elapsed time is 20 [ms] or less, the process proceeds to Step S28. If the amount of the elapsed time is over 20 [ms], the process proceeds to Step S29.

In Step S28, the final motor rotational frequency is set to a larger one between the basic motor rotational frequency and 1500 [ms], and the process ends here.

In Step S29, whether the amount of time elapsed from the start of braking is 100 [ms] or less is determined. If the amount of the elapsed time is 100 [ms] or less, the process proceeds to Step S30. If the amount of the elapsed time is over 100 [ms], the process proceeds to Step S29.

In Step S30, the final motor rotational frequency is set to a smaller one between the basic motor rotational frequency and 800 [ms], and the process ends (first pressure increase).

In Step S31, whether the estimated hydraulic pressure of each of the wheel cylinders 42 is larger than 2 [Mpa] is determined. If the estimated hydraulic pressure is larger than 2 [MPa], the process proceeds to Step S32. If the estimated hydraulic pressure is smaller than 2 [MPa], the process proceeds to Step S33.

In Step S32, the final motor rotational frequency is set to a smaller one between the basic motor rotational frequency and 1100 [ms], and the process ends (second pressure increase).

In Step S33, the final motor rotational frequency is set to a smaller one between the basic motor rotational frequency and the limit value of the motor rotational frequency, and the process ends.

[Operation]

In Embodiment 7, the motor 32 is controlled in accordance with the basic motor rotational frequency when the target hydraulic pressure of each of the wheel cylinders 42 is larger than 5 [MPa], when AEB is being applied or when ESC is being carried out (Step S24 to Step S25). At this time, the gate out valves 33 are controlled to be opened/closed to implement the leak control of the hydraulic pressure, and the second pressure increase takes place. If none of the determination conditions at Step S24 is satisfied, either ACC or LDP, or both ACC and LDP are performed. When the target hydraulic pressure of each of the wheel cylinders 42 is larger than 5 [MPa], it is determined that AEB is being applied.

This makes it possible to carry out the second pressure increase at the time of AEB or ECS requiring urgent action, to thereby promptly ensure the wheel cylinder hydraulic pressure.

In Embodiment 7, the rotational frequency of the motor 32 is set relatively high when the amount of the time elapsed from the start of braking is 20 [ms] or less (Step S27 to Step S28). At this time, the gate out valves 33 continue to be in the closed state so as not to implement the hydraulic pressure leak control, thereby carrying out the first pressure increase.

This makes it possible to carry out the elimination of the backlash between the brake pad and the brake disc at the start of braking and thus to prevent or reduce a response delay in increase of the wheel cylinder hydraulic pressure.

Embodiment 7 carries out the first pressure increase which sets the rotational frequency of the motor 32 to be relatively low when the amount of the time elapsed from the start of braking exceeds 20 [ms] but no more than 100 [ms] (Step S29 to Step S30). At this time, the first pressure increase takes place while the gate out valves 33 are maintained in the closed state so as not to implement the hydraulic pressure leak control.

The operation noise of the motor 32 is likely to annoy the occupant in an early stage of braking, because other noise is low. The noise generation can be prevented or reduced by reducing the rotational frequency of the motor 32 in the early stage of braking.

In Embodiment 7, when the amount of the time elapsed from the start of braking exceeds 100 [ms], the second pressure increase takes place in which the rotational frequency of the motor 32 is set to be high (Step S29 to S31 to S32, or Step S29 to S31 to S33). At this time, the second pressure increase takes place so that the gate out valves 33 are controlled to be opened/closed to carry out the leak control of the hydraulic pressure.

In a late stage of braking, the operation noise of the motor 32 sounds relatively low to the occupant because other noise is also loud. The second pressure increase in the late stage of braking improves the accuracy of the brake fluid pressure control.

[Advantages]

(12) The ITS control unit 1 carries out the first pressure increase when the braking command is issued in the early stage of the pressure increase, and carries out the second pressure increase when the braking command is issued in the late stage of the pressure increase.

Therefore, the noise generation can be prevented or reduced by reducing the rotational frequency of the motor 32 in the early stage of braking. In the late stage of braking, the brake fluid pressure control can be improved in accuracy.

(13) The ITS control unit 1 is configured to carry out the second pressure increase when the vehicle or wheels are in an emergency braking state even if the braking command is issued in the early stage of the pressure increase.

It is then possible to promptly ensure the wheel cylinder hydraulic pressure when the emergency brake is applied.

(14) Embodiment 7 includes the fluid paths 45 (first hydraulic pressure circuit) connecting the master cylinder 21 and the wheel cylinders 42 disposed at the respective wheels; the gate out valves 33 (differential pressure valves) placed in the fluid paths 45 and configured to adjust the differential pressure between the downstream side connected to the wheel cylinder 42-side, and the upstream side connected to the master cylinder 21-side; the plunger pumps 31 (pumps) configured to suck in the brake fluid from the master cylinder 21 and discharge the brake fluid to between the gate out valves 33 of the fluid paths 45 and the wheel cylinders 42; the motor 32 configure to activate the plunger pumps 31; and the ITS control unit 1 (hydraulic pressure control unit) configured to increase/decrease the hydraulic pressures of the wheel cylinders provided to the vehicle by using the gate out valves 33 and the plunger pumps 31 on the basis of the braking force command calculated according to the state of the vehicle or the wheels. When the condition of the braking force command is that the pressure increase demand is lower than the predetermined pressure increase gradient or issued at the early stage of the pressure increase, the ITS control unit 1 carry out the first pressure increase which brings the gate out valves 33 into the closing direction and activates the motor 32 to increase the wheel cylinder hydraulic pressures in accordance with the rotational frequency of the motor 32. When the condition of the braking force command is that the pressure increase demand is equal to or higher than the predetermined pressure increase gradient or issued at the late stage of the pressure increase, the ITS control unit 1 carries out the second pressure increase which sets the motor 32 to operate at predetermined or higher rotational frequency, refluxes the brake fluid from the downstream side toward the upstream side of the first hydraulic pressure circuit through the gate out valves 33 to increase the wheel cylinder hydraulic pressures through the motor 32.

The noise generation can be prevented or reduced by reducing the rotational frequency of the motor 32 at the early stage of the braking. In the late stage of the braking, the brake fluid pressure control can be improved in accuracy.

(15) The ITS control unit 1 is configured to carry out the first pressure increase when the vehicle or the wheels are in an adaptive cruise control state (ACC) where a distance to a preceding car is maintained at predetermined distance, a constant-speed running state (ACC) or a lane departure prevention control state (LDP).

The noise generation therefore can be prevented or reduced by reducing the rotational frequency of the motor 32.

(16) The ITS control unit 1 is configured to carry out the second pressure increase when the vehicle or the wheels are in an emergency braking state (AEB, ESC).

This makes it possible to promptly ensure the wheel cylinder hydraulic pressure by carrying out the second pressure increase in case of major urgency.

(17) Embodiment 7 includes the plunger pumps 31 (pumps) configured to discharge the brake fluid sucked in from the master cylinder 21 into the fluid paths 45 (first hydraulic pressure circuit) connecting the master cylinder 21 and the wheel cylinders 42 disposed at the respective wheels; the gate out valves 33 (differential pressure valves) placed in the fluid paths 45 and configured to adjust differential pressure between the downstream side connected to the wheel cylinder 42-side, and the upstream side connected to the master cylinder 21-side; and the ITS control unit 1 (hydraulic pressure control unit) configured to discharge the brake fluid to between the gate out valves 33 of the fluid paths 45 and the wheel cylinders 42 by using the plunger pumps 31, and increase/decrease, by using the plunger pumps 31, hydraulic pressures of the wheel cylinders provided to the wheels in accordance with the braking force command calculated based on the state of the vehicle or wheels. When the condition of the braking force command is that the pressure increase demand for the wheel cylinders 42 is lower than the predetermined pressure increase responsivity demand, the ITS control unit 1 carries out the first pressure increase and the second pressure increase in accordance with the braking force command. The first pressure increase brings the gate out valves 33 into the closing direction and increases the wheel cylinder hydraulic pressures in accordance with the rotational frequency of the plunger pumps 31. When the condition of braking force command is that the pressure increase demand for the wheel cylinders 42 is equal to or higher than the predetermined pressure increase demand, the second pressure increase sets the motor to operate at the predetermined rotational frequency, refluxes the brake fluid from the downstream side to the upstream side of the fluid paths 45 through the gate out valves 33, and activates the motor 32 to increase the wheel cylinder hydraulic pressures.

When the pressure increase responsivity demand is low, the noise generation can be prevented or reduced by reducing the rotational frequency of the motor 32 at the early stage of braking. When the pressure increase responsivity demand is high, the brake fluid pressure control can be improved in accuracy.

### Another Embodiment

The embodiments of the invention have been explained with the descriptions of Embodiments 1 to 7. The specific configurations of the invention, however, are not limited to Embodiments 1 to 7. Design modifications made without deviating from the gist of the invention are included in the present invention. For example, instead of the plunger pumps, gear pumps or the like may be utilized, which better prevents or reduces the noise generation. As far as at least part of the foregoing problem can be solved or at least part of the advantages can be provided, the constituent elements mentioned in the claims or description may be arbitrarily combined or omitted.

The present application claims priority to Japanese Patent Application No. 2014-144201 filed on Jul. 14, 2014. The entire disclosure of Japanese Patent Application No. 2014-144201 filed on Jul. 14, 2014, including the description, the claims, the drawings and the abstract, is incorporated herein by reference in its entirety.

### REFERENCE SIGNS LSIT

1 ITS control unit (hydraulic pressure control unit)
4 Brake fluid temperature estimation unit
21 Master cylinder
31 Plunger pump (pump)
33 Gate out valve (differential pressure valve)
42 Wheel cylinder
45 Fluid path (first hydraulic pressure circuit)
51 Wheel cylinder hydraulic pressure sensor (wheel cylinder hydraulic pressure calculating unit)

1. A brake control system comprising:
a first hydraulic pressure circuit connecting a master cylinder and a wheel cylinder disposed at each wheel;
a differential pressure valve provided in the first hydraulic pressure circuit and configured to adjust differential pressure between a downstream side connected to a wheel cylinder-side and an upstream side connected to a master cylinder-side;
a pump configured to discharge brake fluid to between the differential pressure valve of the first hydraulic pressure circuit and the wheel cylinder; and
a hydraulic pressure control unit configured to increase hydraulic pressure of the wheel cylinder provided at the wheel by using the differential pressure valve and the pump based on a braking force command calculated according to a state of a vehicle or the wheel, wherein
the hydraulic pressure control unit switches a pressure increase mode, according to the state of the vehicle, between first pressure increase that closes the differential pressure valve and activates the pump to increase the wheel cylinder hydraulic pressure and second pressure increase that allows the brake fluid to leak from the downstream side to the upstream side of the first hydraulic pressure circuit through the differential pressure valve, and activates the pump to increase the wheel cylinder hydraulic pressure.

2. The brake control system according to claim 1, wherein
the hydraulic pressure control unit carries out the first pressure increase when the vehicle or the wheel is in an adaptive cruise control state where a distance to a preceding car is maintained at predetermined distance, a constant-speed running state or a lane departure prevention control state.

3. The brake control system according to claim 2, wherein
the hydraulic pressure control unit carries out the second pressure increase when the vehicle or the wheel is in an emergency braking state.

4. The brake control system according to claim 1, wherein
the hydraulic pressure control unit carries out the first pressure increase during a predetermined time period from start of control.

5. The brake control system according to claim 4, wherein
the predetermined time period is a time period before an actual braking force is generated.

6. The brake control system according to claim 1, wherein
the hydraulic pressure control unit controls rotational frequency of the pump during a predetermined time period from the start of control so that the rotational frequency of the pump is higher than it is during the first increase and the second pressure increase.

7. The brake control system according to claim 6, wherein
the predetermined time period is a time period in which a gap created between a brake disc and a brake pad is eliminated.

8. The brake control system according to claim 1, wherein
the hydraulic pressure control unit carries out the second pressure increase, regardless of the braking force command, when the braking force command is equal to or higher than predetermined hydraulic pressure.

9. The brake control system according to claim 1, wherein
the hydraulic pressure control unit carries out the second pressure increase, regardless of the braking force command, when the vehicle or the wheel is at predetermined or higher speed.

10. The brake control system according to claim 1, comprising:
a brake fluid temperature estimation unit configured to estimate brake fluid temperature, wherein
when the estimated brake fluid temperature is low temperature equal to or lower than predetermined brake fluid temperature, the hydraulic pressure control unit sets rotational frequency of the pump to be lower than it is when the estimated brake fluid temperature is higher than the predetermined brake fluid temperature.

11. The brake control system according to claim 10, wherein
the brake fluid temperature estimation unit estimates the brake fluid temperature on the basis of water temperature of an engine installed in the vehicle.

12. The brake control system according to claim 1, comprising:
a wheel cylinder hydraulic pressure calculating unit configured to calculate hydraulic pressure of the wheel cylinder, wherein
the hydraulic pressure control unit reduces rotational frequency of the pump by predetermined rotational frequency when the calculated wheel cylinder hydraulic pressure becomes equal to or higher than predetermined hydraulic pressure during the second pressure increase.

13. The brake control system according to claim 1, comprising:
a suction oil passage through which the pump sucks the brake fluid from the master cylinder, and
a suction valve placed in the suction oil passage, wherein
the hydraulic pressure control unit turns the suction valve to an open state during the first increase and the second pressure increase, and opens/closes the suction valve during a time period when the hydraulic pressure is maintained.

14. The brake control system according to claim 13, wherein
the hydraulic pressure control unit detects that a brake pedal is operated by a driver during the time period when the hydraulic pressure is maintained.

15. The brake control system according to claim 1, wherein
the hydraulic pressure control unit carries out the first pressure increase when the braking command is issued in an early stage of the pressure increase, and carries out the second pressure increase when the braking command is issued in a late stage of the pressure increase.

16. The brake control system according to claim 15, wherein
when the vehicle or the wheel is in an emergency braking state, the hydraulic pressure control unit carries out the second pressure increase even if the braking command is issued in the early stage of the pressure increase.

17. A brake control system comprising:
a first hydraulic pressure circuit connecting a master cylinder and a wheel cylinder disposed at each wheel;
a differential pressure valve provided in the first hydraulic pressure circuit and configured to adjust differential pressure between a downstream side connected to a wheel cylinder-side and an upstream side connected to a master cylinder-side;
a pump configured to suck brake fluid from the master cylinder and discharge the brake fluid to between the differential pressure valve of the first hydraulic pressure circuit and the wheel cylinder;
a motor configured to activate the pump; and
a hydraulic pressure control unit configured to increase/decrease hydraulic pressure in the wheel cylinder provided to a vehicle by using the differential pressure valve and the pump on the basis of a braking force command calculated according to a state of a vehicle or the wheel, wherein
when a condition of the braking force command is that a pressure increase demand is lower than a predetermined pressure increase gradient or issued at an early stage of pressure increase, the hydraulic pressure control unit carries out first pressure increase which brings the differential pressure valve into a closing direction, activates the motor to increase the wheel cylinder hydraulic pressure in accordance with rotational frequency of the motor; when the condition of the braking force command is that the pressure increase demand is equal to or higher than the predetermined pressure increase gradient or issued at a late stage of the pressure increase, the hydraulic pressure control unit carries out second pressure increase which sets the motor to operate at predetermined or higher rotational frequency, refluxes the brake fluid from the downstream side toward the upstream side of the first hydraulic pressure circuit through the differential pressure valve, and activates the motor to increase the wheel cylinder hydraulic pressure.

18. The brake control system according to claim 17, wherein the hydraulic pressure control unit carries out the first pressure increase when the vehicle or the wheel is in an adaptive cruise control state where a distance to a preceding car is maintained at predetermined distance, a constant-speed running state or a lane departure prevention control state.

19. The brake control system according to claim 17, wherein the hydraulic pressure control unit carries out the second pressure increase when the vehicle or the wheel is in an emergency braking state.

20. The brake control system according to claim 17, wherein the hydraulic pressure control unit carries out the first pressure increase during a predetermined time period from start of control.

21. The brake control system according to claim 17, wherein the hydraulic pressure control unit controls rotational frequency of the pump during a predetermined time period from start of control so that the rotational frequency of the pump is higher than it is during the first increase and the second pressure increase.

22. A brake control system comprising:
a pump configured to discharge brake fluid sucked in from a master cylinder into a first hydraulic pressure circuit connecting the master cylinder and a wheel cylinder disposed at each wheel;
a differential pressure valve placed in the first hydraulic pressure circuit and configured to adjust differential pressure between a downstream side connected to a wheel cylinder-side, and an upstream side connected to a master cylinder-side; and
a hydraulic pressure control unit configured to discharge the brake fluid to between the differential valve of the first hydraulic pressure circuit and the wheel cylinder by using the pump, and increase/decrease hydraulic pressure in the wheel cylinder provided to the wheel in accordance with a braking force command calculated based on a state of a vehicle or the wheel by using the differential valve and the pump, wherein
the hydraulic pressure control unit carries out first pressure increase and second pressure increase in accordance with the braking force command;
the first pressure increase brings the differential pressure valve into a closing direction when a condition of the braking force command is that a pressure increase demand for the wheel cylinder is lower than a predetermined pressure increase responsivity demand, and increases the wheel cylinder hydraulic pressure in accordance with rotational frequency of the pump; and
the second pressure increase sets the motor to operate at predetermined or higher rotational frequency, refluxes the brake fluid from the downstream side to the upstream side of the first hydraulic pressure circuit through the differential pressure valve, and activates the motor to increase the wheel cylinder hydraulic pressure, when the condition of braking force command is that the pressure increase demand for the wheel cylinder is equal to or higher than the predetermined pressure increase demand.
